(19) United States
(12) Patent Application Publication
(10) Pub. No.: US 2004/0098294 A1
(43) Pub. Date: May 20, 2004

(54) Adaptable resource model

(75) Inventors: Christopher Dean, Ottawa (CA); Stephen Mason, Gloucester (CA); Cyril Soga, Orleans (CA); Julien Brainerd, Nepean (CA); Alain Lemoine, Ottawa (CA); Ed Maciver, Gloucester (CA); Dmytro Toptygin, Ottawa (CA); David Cuillerier, Ottawa (CA)

Correspondence Address: OBLON, SPIVAK, MCCLELLAND, MAIER & NEUSTADT, P.C., 1940 DUKE STREET, ALEXANDRIA, VA, 22314, US

(73) Assignee: EFTIA OSS SOLUTIONS INC., Ottawa (CA)

(21) Appl. No.: 10/654,943

(22) Filed: Sep. 5, 2003

Related U.S. Application Data
(60) Provisional application No. 60/408,289, filed on Sep. 6, 2002.

(51) Int. Cl. G06F 17/60

(52) U.S. Cl. 705/8

(57) ABSTRACT

The present invention relates to a method and a data structure for defining a resource of a desired type within a resource management application. The method for creating a resource comprising steps for: selecting a catalog based on the desired type; identifying a template associated with the catalog; creating an initial instance of the resource; creating attributes associated with the resource based on definitions specified by the catalog and applying primary validations specified by the catalog; establishing relationships with the resource by applying constraints associated with the template and the catalog; and applying secondary validations associated with the catalog and the template. The data structure lends itself to being changed or augmented. This permits the modification or addition of resource type definitions without necessitating changes to computer program code in the resource management application.

### FIELD OF INVENTION

The present invention relates to the field of modeling resources for manipulation and administration by computer program applications. In particular to such modeling in a dynamic resource environment.

### BACKGROUND

Computer programs that are used in the management or administration of physical and logical resources typically model (i.e. maintain proxies for) the resources under management. Various computer program implementations using the well known “object oriented” methodology use a hierarchy of class and sub-class definitions on which are based the instantiations of the resource proxies commonly referred to as ‘managed objects’. The hierarchy of classes and sub-classes permits the simultaneous benefits of ease of implementation (e.g. through code reuse) provided by the superior classes together with the specialization of behavior provided by the subordinate classes (i.e. sub-classes). This approach using broad superior classes from which are derived more specialized subordinate classes is often referred to as inheritance.

The benefits of inheritance-based implementations are well known and best exploited using a well-architected hierarchy of classes and subclasses. When the nature of the resources to be modeled are well understood at the time of the computer program implementation and when the nature and diversity of the resources remains largely static after the computer program implementation, the common approach of casting the class and subclass definitions at program code compilation time works adequately. However, where the natures of the resources are less well understood or where the nature and range of resources change over time, the compilation time casting of classes and subclasses is problematic. This approach necessitates frequent modification, re-compilation and re-installation of the program code. The latency of response to change and the aggregate costs incurred can render the computer programs using the compilation time casting of class and subclass definitions ineffective in dynamic resource applications. An approach that is more responsive and adaptive to changes in the nature and diversity of resources is required.

### SUMMARY OF INVENTION

In accordance with one aspect of the present invention, a method of creating a resource of a desired type ready for use in a resource management system having a plurality of templates each defining a resource category and a plurality of catalogs each specifying a resource type, each catalog in the plurality of catalogs being associated with one of the plurality of templates, each template and each catalog having associated primary validations, relationship constraints and secondary validations, the method comprising steps for: selecting a catalog, based on the desired type, from the plurality of catalogs; identifying a template from the plurality of templates that is associated with the catalog; creating an initial instance of the resource; establishing a plurality of attributes associated with the resource based on definitions specified by the catalog and by the template, and validating the attributes by applying primary validations associated with the catalog and with the template; establishing relationships with the resource by applying relationship constraints associated with the template and with the catalog; and applying secondary validations associated with the catalog and with the template to the attributes associated with the resource.

In accordance with another aspect of the present invention, a data structure used in creating a resource of a desired resource type within a resource management application according to the method described above, comprising data elements representing: a template defining a resource category; a catalog, associated with the template, specifying a resource type; an attribute master set; a template subset of attributes, selected from the attribute master set, and attribute primary validations associated with the template; a catalog subset of attributes, selected from the template subset of attributes, and primary attribute validations associated with the catalog; relationship constraints associated with the template; relationship constraints associated with the catalog; secondary validations associated with the template; and secondary validations associated with the catalog.

In accordance with yet another aspect of the present invention, a computer program product for use in creating a resource of a desired type ready for use in a resource management system having a plurality of templates each defining a resource category and a plurality of catalogs each specifying a resource type, each catalog in the plurality of catalogs being associated with one of the plurality of templates, each template and each catalog having associated primary validations, relationship constraints and secondary validations, the computer program product comprising computer executable program code devices for: a) selecting a catalog, based on the desired type, from the plurality of catalogs; b) identifying a template from the plurality of templates that is associated with the catalog; c) creating an initial instance of the resource; d) establishing a plurality of attributes associated with the resource based on definitions specified by the catalog and by the template, and validating the attributes by applying primary validations associated with the catalog and with the template; e) establishing relationships with the resource by applying relationship constraints associated with the template and with the catalog; and f) applying secondary validations associated with the catalog and with the template to the attributes associated with the resource.

Other aspects and features of the present invention will become apparent to those ordinarily skilled in the art upon review of the following description of specific embodiments of the invention in conjunction with the accompanying figures.

### BRIEF DESCRIPTION OF DRAWINGS

The present invention will be described in conjunction with the drawings in which:

FIG. 1 represents data structures and their inter-relationships in an exemplary embodiment of the present invention.

FIG. 2 illustrates a flowchart representing a process for creating a new resource in an exemplary embodiment of the present invention.

FIG. 3 illustrates a flowchart representing a process for creating a new template in an exemplary embodiment of the present invention.

FIG. 4 illustrates a flowchart representing a process for creating a new catalog in an exemplary embodiment of the present invention.

FIG. 5 represents an exemplary computing platform on which the present invention can be implemented.

### DETAILED DESCRIPTION

The present invention relates to a method and a data structure for defining resources within a resource management application. References herein to resources refer to proxies, within a resource model of the application, for actual physical or conceptual (logical) resources rather than to the actual resources themselves. A definition of a resource comprises: a classification of the resource, attributes that describe the resource, validations for the attributes, and relationships in which the resource classification permits participation.

In the present invention, the definition for a resource type is embodied in data within data structures (e.g. inter-related data tables). The data structures lend themselves to being changed or augmented. This permits the modification or addition of resource type definitions without necessitating changes to computer program code.

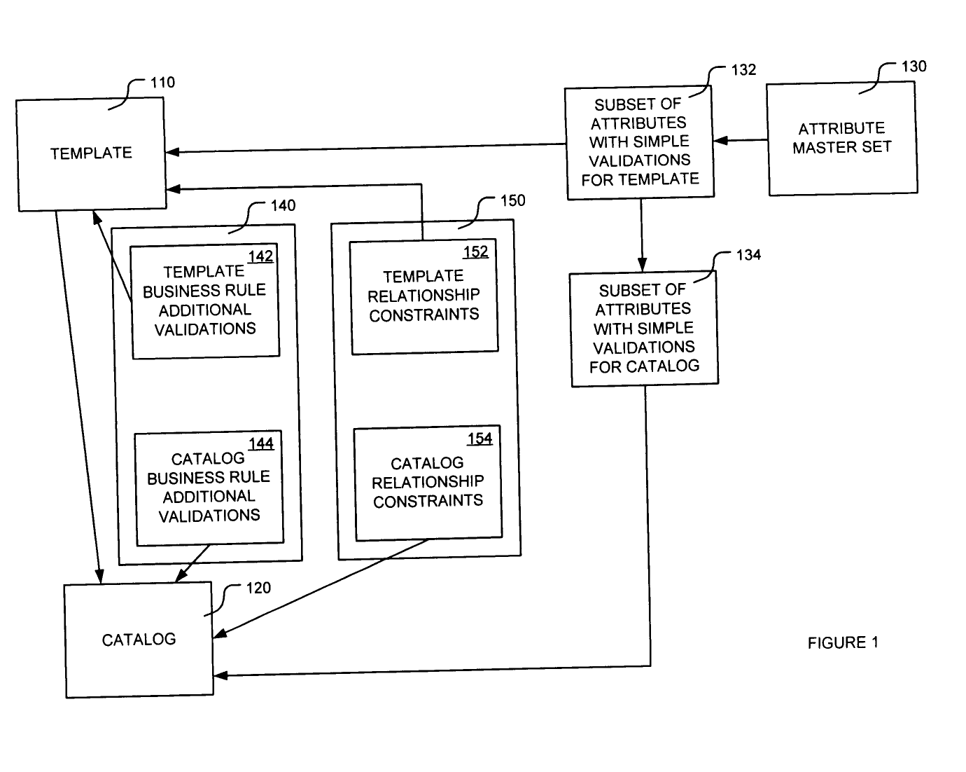

FIG. 1 and the associated description represent data structures and their inter-relationships in an exemplary embodiment of the present invention. The definition of a resource is provided by a catalog 120 that is based on a template 110. The template 110 defines a category that is used in the classification of the resource. The catalog 120 is used in the specification of a resource type or subtype. The catalog 120 is associated with (based on) the template 110. The resource is instantiated using the catalog 120 that specifies a resource type or a resource subtype desired for the resource.

The template 110 has associated with it a set of attributes and simple (primary) validations for these attributes 132. The attributes associated with the template 110 are a subset from an attribute master set 130. The catalog 120 has associated with it a set of attributes and simple (primary) validations for these attributes 134. The catalog 120 inherits all of the attributes and simple validations 132 from the template 110 with which it is associated. The catalog 120 can also redefine (override) attributes and simple validations inherited from the template. Each simple (primary) validation makes reference to an attribute to be validated the simple (primary) validation does not make reference to any other attributes.

Additional (secondary) validations, beyond the simple validations associated with attributes, are provided by, for example, business rules 140. Additional validations are validations that reference, for example, attributes other than the attribute being validated (e.g. where the attribute being validated needs to be compared with another attribute.) Business rule additional validations associated with a template 142 can be applied to all resources of the category defined by the template 110. Business rule additional validations associated with a catalog 144 can be applied to all resources specified using the catalog 120. In another embodiment of the present invention the additional (secondary) validations can be provided by other well know mechanisms such as, for example, validation data elements that reside in a data structure, table, database or other similar data representation mechanisms

The relationships that the resource is permitted to participate in are defined in relationship constraints 150. Relationship constraints associated with a template 152 can be applied to all resources of the category defined by the template 110. Relationship constraints associated with a catalog 154 can be applied to all resources specified using the catalog 120.

As described above, the template 110 defines a resource category and provides for attributes to be associated with resources within the category. The template 110 specifies a type and subtype for resources within the category. Table 1 represents sample templates 110, one per row, as defined within an exemplary embodiment of the present invention.

TABLE 1
Sample Templates

| Template | Template | | | | |
|---|---|---|---|---|---|
| ID | name | Type ID | Type | Subtype ID | Subtype |
| 90 | Domain | 1 | Domain | 1 | Null |
| 91 | Geopolitical | 1 | Domain | 2 | Geopolitical |
| 100 | Site | 2 | Site | 1 | Null |
| 101 | POP | 2 | Site | 3 | POP |
| 102 | Switch | 2 | Site | 4 | Switch |

A template 110 has a Template ID, a Type ID and a Subtype ID that are unique numerical identifiers. The template also has a Template Name, a Type and a Subtype which are textual identifiers associated with the Template ID, Type ID and Subtype ID respectively. The Type ID/Type and Subtype ID/Subtype define the resource classification associated with the template.

Associated with each template 110 are attributes that describe the resources within the classification of the template. The attributes are drawn from an attribute master set 130. Table 2 represents a sample attribute master set 130 in an exemplary embodiment of the present invention.

TABLE 2
Sample Attribute Master Set

| Attribute ID | Attribute name | Default label | Attribute type |
|---|---|---|---|
| 1 | Manufacturer | Manufacturer | String |
| 2 | Product_Line | Product Line | String |
| 3 | Model_# | Model Number | String |
| 4 | Description | Description | String |
| 5 | Bar_Code | Bar Code | String |
| 6 | Cost Recurring | Recurring Cost | Complex |
| 7 | Cost One-time | One-Time Cost | Complex |
| 8 | Cost_List | Cost List | List |
| 9 | Amount | Amount (US$) | Float |
| 10 | Date | Start Date | Date |
| 11 | Sequence# | Sequence # | Integer |
| 12 | Recurring_frequency | Recurring | Integer |
| | | Frequency | |
| 13 | Number_address_list | Number Address | List |
| | | List | |
| 14 | IP_Address | IP Address | String |
| 15 | Telephone# | Telephone | String |
| | | Number | |
| 16 | Utilization | Utilization | Complex |
| 17 | Availability | Availability | String |
| 18 | Availability_port | Port Availability | Complex |
| 19 | Availability_slot | Slot Availability | Complex |

An attribute (corresponding to a row in the Sample Attribute Master Set table) has an Attribute ID, an Attribute Name, a Default Label and an Attribute Type. The Attribute ID is a unique numerical identifier for the attribute. The Attribute name is a textual identifier corresponding to the Attribute ID. The Default Label is a textual descriptor that is associated with the attribute. The Attribute Type defines the data type of the attribute. The Attribute Type is selected from types: string, integer, list, date, float, complex and other similar data types which may vary from one implementation to another. The type ‘list’ permits an attribute to comprise multiple attributes of a type. The type ‘complex’ permits an attribute to comprise multiple attributes of various types in a defined structure.

Table 3 represents a sample template field-list for associating attributes with a template in an exemplary embodiment of present invention.

TABLE 3
Sample Template Field-List

| Template | Template | Attribute | | Default | Value | | | User |
|---|---|---|---|---|---|---|---|---|
| ID | name | ID | Label | value | list | Mandatory | Hidden | Modifiable |
| 103 | Equipment | 1 | Manufacturer | Nortel | 1 | Yes | No | No |
| 103 | Equipment | 2 | Product Line | null | 2 | No | No | Yes |
| 103 | Equipment | 3 | Model # | null | | Yes | No | No |
| 103 | Equipment | 4 | Description | null | | No | No | Yes |
| 103 | Equipment | 5 | CLEI | null | | No | Yes | No |
| 103 | Equipment | 6 | Bar Code | null | | Yes | No | No |
| 103 | Equipment | 8 | Cost List | null | | No | No | Yes |

Each row in the Template Field-List table defines an attribute associated with a Template. A Template ID identifies a template for which an attribute is defined. The Template ID is a reference to a Template ID in the Template table (see Table 1). Similarly, a Template Name is a reference to a Template Name in the Template table. An Attribute ID is a reference to an Attribute ID in the Attribute Master-Set table (see Table 2) and a Label is a reference to a Default Label in the same table. The next three entries in the row (Default Value, Value List, and Mandatory) support validation of a value for the attribute. The Default Value specifies a default value, if any, for the attribute. The Value List is a selector into another table (the Value List table, see Table 4) that enumerates the valid values which the attribute can take on. The Mandatory entry is a Boolean that indicates whether or not a value is required for the attribute. Finally a Hidden entry and a User Modifiable entry indicate whether the attribute is normally viewable by a user of the template and whether the user can modify the attribute respectively.

Table 4 represents a sample value list table. Attributes in, for example, a template field list that reference a value list (identified by a List ID) in the value list table are restricted to taking on values (List Entries) associated with the value list.

TABLE 4
Sample Value List

| List ID | Entry ID | List Name | List Entry |
|---|---|---|---|
| 1 | 1 | Manufacturer | Nortel |
| 1 | 2 | Manufacturer | Cisco |
| 1 | 3 | Manufacturer | Lucent |
| 2 | 1 | Product Name | OPTera |
| 2 | 2 | Product Name | Catalyst |

The template 110 defines a category of resources while the catalog 120 defines one specific type or subtype of resource. The catalog 120 is associated with the template 110 from which it inherits an initial definition of resources that it can further refine. A catalog 120 defines an attribute list and relationship constraints for a resource type or a subtype within a resource category specified in a template. Table 5 represents sample catalogs 120 as defined in an exemplary embodiment of the present invention.

TABLE 5
Sample Catalogs

| Catalog | | | | |
|---|---|---|---|---|
| ID | Template ID | Type | Subtype | Catalog name |
| 1000 | 91 | Domain | Geopolitical | Standard Geopolitical |
| | | | | Domain |
| 1001 | 101 | Site | POP | Standard POP Site |
| 1002 | 102 | Site | Switch | Standard Switch Site |

Each catalog 120 (corresponding to a row in the Catalog table) has a Catalog ID, a Template ID, a Type, a Subtype and a Catalog Name. The Catalog ID is a unique numeric identifier that identifies a catalog. The Catalog Name is a textual identifier that corresponds to the Catalog ID. The Template ID corresponds to a Template ID in the Template table (see Table 1) for a template with which the catalog is associated. The Type and Subtype are the same as those of the above referenced template in the Template table.

The association of attributes with a catalog 120 provides a mechanism for refining the attributes from the list of attributes for a template (as represented in the Template Field-List table) with which a catalog 120 is associated. Table 6 represents a catalog field-list for associating attributes with a catalog in an exemplary embodiment of the present invention.

TABLE 6
Catalog Field-list

| Catalog | Template | Catalog | Attribute | | Default | Value | | | User |
|---|---|---|---|---|---|---|---|---|---|
| ID | ID | name | ID | Label | Value | List | Mandatory | Hidden | Modifiable |
| 1000 | 91 | Standard | 1 | ID | null | | Yes | No | Yes |
| | | Geo- | | | | | | | |
| | | political | | | | | | | |
| | | Domain | | | | | | | |
| 1000 | 91 | Standard | 2 | Name | null | | Yes | No | Yes |
| | | Geo- | | | | | | | |
| | | political | | | | | | | |
| | | Domain | | | | | | | |
| 1000 | 91 | Standard | 32 | Root | null | | Yes | No | Yes |
| | | Geo- | | Resource | | | | | |
| | | political | | | | | | | |
| | | Domain | | | | | | | |
| 1000 | 91 | Standard | 29 | Minimum | null | | Yes | No | Yes |
| | | Geo- | | Threshold | | | | | |
| | | political | | | | | | | |
| | | Domain | | | | | | | |
| 1000 | 91 | Standard | 30 | Maximum | null | | Yes | No | Yes |
| | | Geo- | | Threshold | | | | | |
| | | political | | | | | | | |
| | | Domain | | | | | | | |
| 1000 | 91 | Standard | 31 | Total Cost | null | | No | No | Yes |
| | | Geo- | | | | | | | |
| | | political | | | | | | | |
| | | Domain | | | | | | | |
| 1001 | 101 | Standard | 1 | ID | null | | Yes | No | Yes |
| | | POP Site | | | | | | | |
| 1001 | 101 | Standard | 2 | Name | null | | Yes | No | Yes |
| | | POP Site | | | | | | | |
| 1001 | 101 | Standard | 4 | Address1 | null | | Yes | No | Yes |
| | | POP Site | | | | | | | |
| 1001 | 101 | Standard | 5 | Address2 | null | | Yes | No | Yes |
| | | POP Site | | | | | | | |
| 1001 | 101 | Standard | 8 | Cost | null | | No | No | Yes |
| | | POP Site | | (US$) | | | | | |
| 1001 | 101 | Standard | 33 | Circuit | null | | Yes | No | No |
| | | POP Site | | CLLI | | | | | |
| 1001 | 101 | Standard | 29 | Minimum | null | | Yes | No | Yes |
| | | POP Site | | Threshold | | | | | |
| 1001 | 101 | Standard | 30 | Maximum | null | | Yes | No | Yes |
| | | POP Site | | Threshold | | | | | |
| 1001 | 101 | Standard | 31 | Total Cost | null | | Yes | No | Yes |
| | | POP Site | | | | | | | |
| 1001 | 101 | Standard | 7 | Postal | null | | Yes | No | Yes |
| | | POP Site | | Code | | | | | |

Each entry (row) in the Catalog Field-list table, defining an attribute associated with a catalog, has a Catalog ID, a Template ID, a Catalog Name, an Attribute ID, a Label, Default Value, Value List, Mandatory, Hidden and User Modifiable. The Catalog ID and Catalog Name correspond to a Catalog ID and Catalog Name respectively in the Catalog table (see Table 5) for a catalog for which the entry defines an attribute. The Template ID corresponds to a Template ID in the Template table (see Table 1) for a template with which the catalog is associated. The Attribute ID is a reference to an Attribute ID in the Attribute Master-Set table (see Table 2) and the Label is a reference to an associated Default Label in the same table. The next three entries in the row (Default Value, Value List, and Mandatory) support validation of a value for the attribute. The Default Value specifies a default value, if any, for the attribute. The Value List is a selector into another table (the Value List table, see Table 4) that enumerates the valid values that the attribute can take on. The Mandatory entry is a Boolean that indicates whether or not a value is required for the attribute. Finally a Hidden and a User Modifiable entry indicate whether the attribute is normally viewable by a user of the catalog and whether the user can modify the attribute respectively.

The inter-play between the catalog 120 and the template 110, with which the catalog 120 is associated, in the definition of a resource is as follows. A resource created based on a catalog 120 has attributes and attribute validations as defined by the catalog 120 via the catalog field-list. In addition the resource has attributes and attribute validations as defined by the template 110 via the template field-list for each Attribute ID in the template field-list that does exist in the catalog field-list for the catalog 120. These attributes and attribute validations are said to be inherited from the template 110. When the same Attribute ID appears for the catalog 120 and for the template 110 in both the catalog field-list and in the template field-list, the definition in the catalog field-list takes precedence.

Relationships specify how two resources relate to each other. All relationships have a Left Hand Side (LHS) and a Right Hand side (RHS). Table 7 represents sample relationship types for relating resources in an exemplary embodiment of the present invention.

TABLE 7
Sample Relationship Types

| | Relationship Type | |
|---|---|---|
| Relationship Type ID | Name | Name Reversed |
| 1 | Contained by | Contains |
| 2 | Consumed by | Consumes |
| 3 | Located at | Locates |
| 4 | Resides on | Resident |

Relationship types used to relate resources are specified in a relationship type table, such as represented in Table 7. The relationship type table contains relationship types that are identified by a unique identifier (Relationship Type ID). The relationship type also has a Relationship Type Name for ease of identification. The Name Reversed is the relationship name when the direction of the relationship is reversed, for example when RHS and LHS resources are switched. For example: a “Card” is <Contained By> a “Shelf” while a “Shelf” <Contains> a “Card.”

Referring to the relationship types defined by the Relationship Type table (see Table 7), the relationship type in which a specific resource may participate can be configured. This configuration is captured as constraints that are applied to a Template or a Catalog. Table 8 represents sample relationship constraints in an exemplary embodiment of the present invention.

TABLE 8
Sample Relationship Constraints

| LHS | LHS | | | RHS | RHS |
|---|---|---|---|---|---|
| Catalog or | Catalog or | | | Catalog or | Catalog or |
| Template | Template | Relationship | Relationship | Template | Template |
| ID | name | TypeID | typ nam | ID | name |
| 1000 | Standard | 1 | ContainedBy | 1000 | Standard |
| | Geopolitical | | | | Geopolitical |
| | Domain | | | | Domain |
| 1001 | Standard | 1 | ContainedBy | 1000 | Standard |
| | POP Site | | | | Geopolitical |
| | | | | | Domain |
| 1001 | Standard | 1 | ContainedBy | 1001 | Standard |
| | POP Site | | | | POP Site |
| 1001 | Standard | 1 | ContainedBy | 1002 | Standard |
| | POP Site | | | | Switch Site |
| 1002 | Standard | 1 | ContainedBy | 1000 | Standard |
| | Switch Site | | | | Geopolitical |
| | | | | | Domain |
| 1002 | Standard | 1 | ContainedBy | 1001 | Standard |
| | Switch Site | | | | POP Site |
| 1002 | Standard | 1 | ContainedBy | 1002 | Standard |
| | Switch Site | | | | Switch Site |

Each entry (row) in the Relationship Constraint table has a Relationship Type ID and a Relationship Type Name that correspond to a Relationship Type ID and an associated Relationship Name in the Relationship Type table (see Table 7) for a relationship type. The entry further comprises a LHS Catalog or Template ID and an associated LHS Catalog or Template Name which identify a Catalog or a Template (in the Catalog or Template tables respectively) which is validate for inclusion in the LHS of the relationship. Similarly the RHS Catalog or Template ID and an associated RHS Catalog or Template Name identify a Catalog or a Template which is validate for inclusion in the RHS of the relationship.

In an alternative embodiment of the present invention, other data representations including, but not limited to, different table structures, linked data records, relational databases, object-oriented databases, extensible mark-up language (XML) structures and other similar data representations can be used in place of the representation illustrated for each of the above tables. The alternative data structures would represent data elements and their inter-relationships similar to those represented in the above tables.

Business rules are organized into business rule sets. Each business rule (BR) set contains one or more business rules. In an exemplary embodiment of the Business Rule Manager 140 a business rule set is identified by its name using the following syntax:

BR Set Name:<Entity name>_<Entity type>_<Entity sub-type>_<Operation>_<Stage>.

Based on the first four elements of the business rule set name, a collection of business rule sets is gathered for a given operation on a specific entity. The gathered business rule sets are then executed based on their stage. The entities in this embodiment are: ‘resource’, ‘relationship’, and ‘catalog’ as previously described. The <Entity Name> component of the BR Set Name identifies to which entity the business rule set applies. Similarly, the business rule set applies to entities whose type and sub-type match those in the BR Set Name. The type and sub-type are optional, if these fields are left blank, the business rule set applies to all entities that match the <Entity Name> component. Entities having the <Entity Name> component set to ‘relationship’ do not have a type or sub-type.

The <Operation> component of the BR Set Name signifies a type of operation on the entity during which the business rule set applies. In an embodiment of the present invention, a business rule set is invoked for operations as follows: create—business rule set invoked when entity is created, retrieve—business rule set invoked when the entity is accessed, update—business rule set invoked when the entity is modified and delete—business rule set invoked when the entity is deleted.

The <Stage> component of the BR Set Name determines the sequence in which the rule set will be executed. In an embodiment of the present invention the stages are defined in sequential order of execution as: Permission, Attribute, Preferred Relationship, State and Relationship.

The business rule set contains atomic business rules. Each business rule has an associated name, a priority and rule details. The name identifies a business rule. For example, in an exemplary embodiment of the present invention a business rule named CircuitLink within a business rule set named Resource_Create_Preferred_Realationship resolves the preferred relationship for a circuit link resource. The priority is a number weight allocated to a business rule to ensure its execution sequence. In an exemplary embodiment of the present invention, the priority takes on an integer value between 1 and 10. Business rules with numerically smaller priorities execute before business rules with numerically higher priorities.

The format of the rule details associated with a business rule is:

IF

{Condition 1, Condition 2, Condition 3, etc . . . }

THEN

{Action 1, Action 2, Action 3, etc . . . }

Conditions are expressions that evaluate to true or false. An example condition is “Is the resource type=‘Equipment”?”. Actions can include various computer executable functions such as: setting the value of a data/storage parameter, sending an alert, creating a resource and other similar executable functions. If all of the conditions provided in the business rule evaluate as true, then each of the actions is executed sequentially.

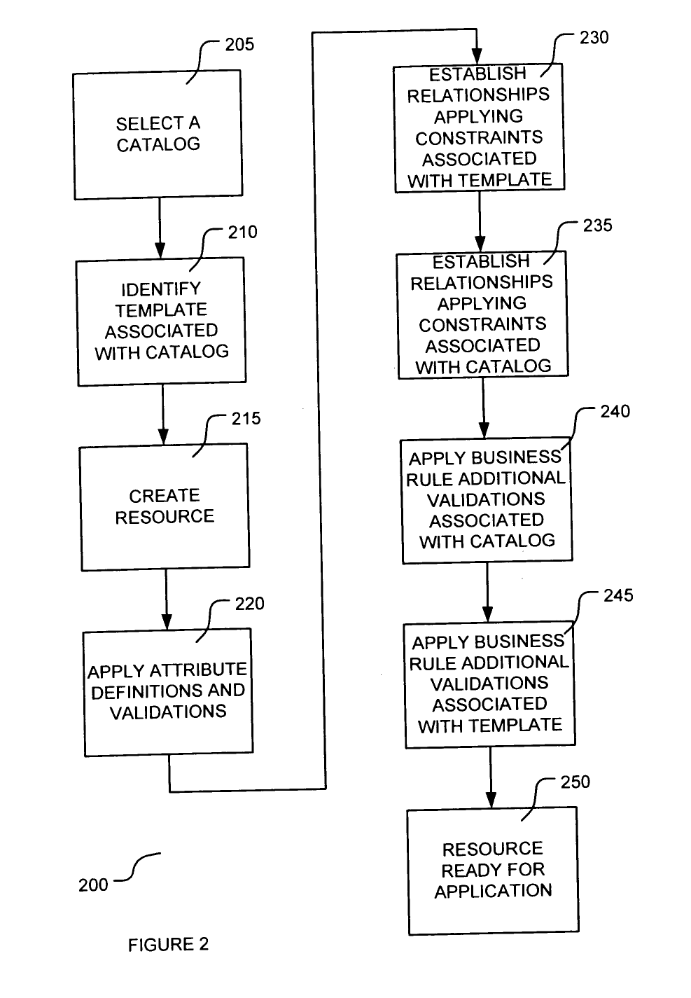

FIG. 2 illustrates a flowchart representing a process 200 for creating a new resource in an exemplary embodiment of the present invention. The creation of a new resource begins with the selection of a catalog 205 that specifies the resource type or subtype that is desired for the resource. Given that each catalog is associated with a template, a template associated with the catalog can be identified 210. An initial instance of the resource is created 215 to which further steps in the creation process will be applied. Attributes for the resource are established and validated using definitions and validations associated with the catalog 220 including those inherited from the template. Relationships in which the resource participates are established and validated applying validations associated with the template 230 and validations associated with the catalog 235. After the foregoing validations further validation of attributes for the resource is applied using the business rule additional validations associated with the catalog 240 and with the template 245. Business rule validations can include for example: verifying the uniqueness of resource identifiers, verifying that the user initiating a resource operation has the appropriate permission/privileges to do so and other similar validations. Upon successful completion of all of the validation steps, the resource is ready for use in the computer program application 250.

The present invention provides for the creation of new a resource of a given type or sub-type as specified by an appropriate catalog. A catalog in turn is based on a template that defines a resources category (classification). When a catalog does not exist for the type or sub-type of the resource to be created, then a new catalog specifying the type or sub-type can be created and used in the creation of the resource. When the new resource to be created does not fall within the resource category (classification) defined by an existing template, a new template can be created defining the desired category (classification). Once a template defining the desired category (classification) exists, a catalog specifying the appropriate type or sub-type can be created.

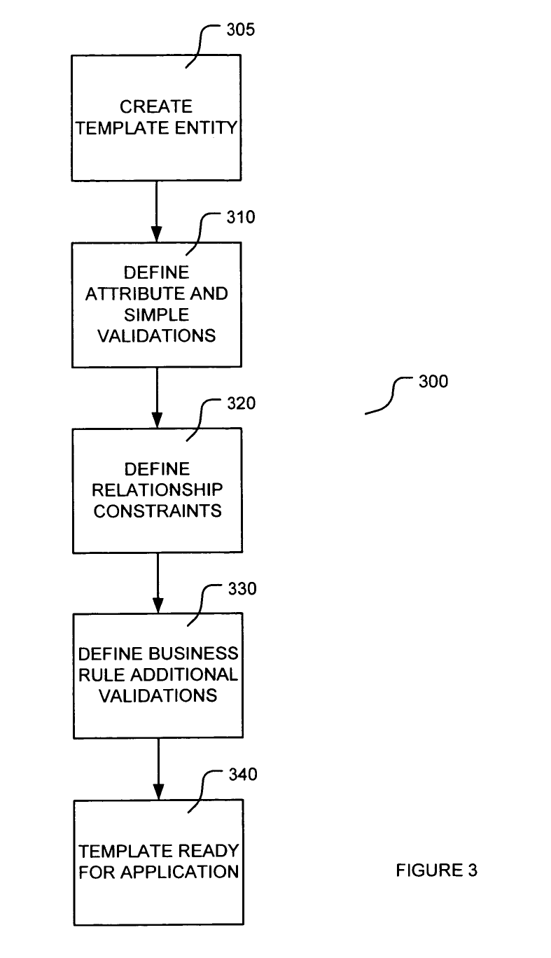

FIG. 3 illustrates a flowchart representing a process 300 for creating a new template in an exemplary embodiment of the present invention. First an initial template is created 305 to which further steps in the creation process will be applied. Then the attributes and simple validations to be associated with the template are defined 310. Next the relationship constraints to be associated with the template are defined 320. Business rule additional validations to be associated with the template are also defined 330. After the fore going steps are completed, the template is ready for application 340.

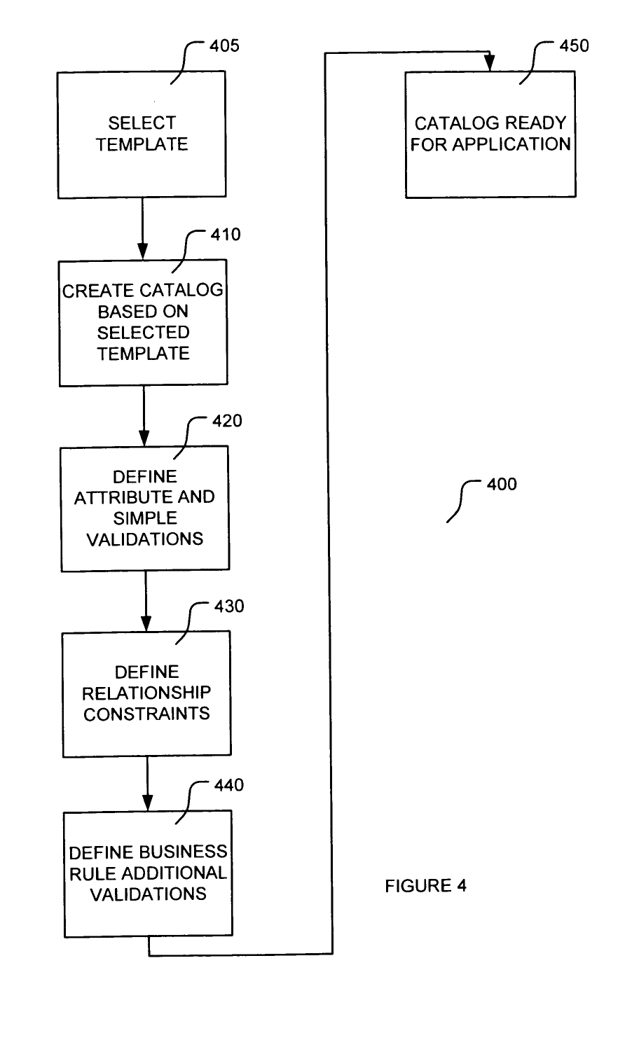

FIG. 4 illustrates a flowchart representing a process 400 for creating a new catalog in an exemplary embodiment of the present invention. Creation of the catalog begins with the selection of a template 405 on which the catalog will be based. Next an initial catalog, based on the selected template, is created 410 to which further steps in the creation process will be applied. Attributes and simple validations to be associated with the catalog are defined 420. Relationship constraints to be associated with the catalog are also defined 430. Business rule additional validations to be associated with the catalog are defined 440. After the fore going steps are completed, the catalog is ready for application 450.

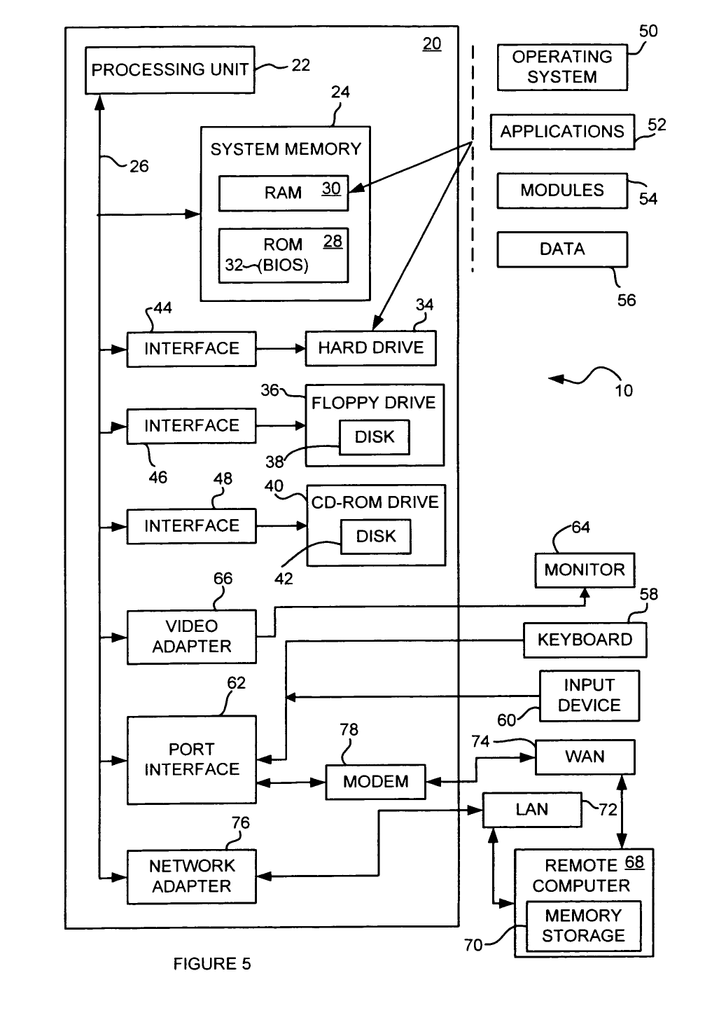

FIG. 5 and the associated description represent an example of a suitable computing environment in which the invention may be implemented. While the invention is described in the context of implementation in the form of computer-executable instructions of a program that runs on a conventional computing platform, the invention can also be implemented in combination with other program modules.

Generally, program modules include routines, programs, components, data structures and the like that perform particular tasks or implement particular abstract data types. Further, the present invention can also be implemented using other computer system configurations, including multiprocessor systems, personal computers, mainframe computers, hand-held devices, microprocessor-based or programmable consumer electronics and the like. The invention can also be practiced in distributed computing environments wherein tasks are performed by remote processing devices that are linked through a communications network. In a distributed computing environment, program modules may be located in both local and remote memory storage devices.

With reference to FIG. 5, an exemplary system 10 includes a conventional computer 20, including a processing unit 22, a system memory 24, and a system bus 26 that couples various system components including the system memory 24 to the processing unit 22. The system bus 26 includes several types of bus structures including a memory bus or memory controller, a peripheral bus, and a local bus using any of a variety of conventional bus architectures (e.g., PCI, VESA, ISA, EISA etc.)

The system memory 24 includes read only memory (ROM) 28 and random access memory (RAM) 30. A basic input/output system (BIOS) 32, containing the basic routines that help to transfer information between elements within the computer 20, such as during start-up, is stored in the ROM 28. The computer 20 also includes a hard disk drive 34, magnetic disk drive 36 (to read from and write to a removable disk 38), and an optical disk drive 40 (for reading a CD-ROM disk 42 or to read from or write to other optical media). The drives 34, 36 and 40 are connected to the system bus 26 by interfaces 44, 46 and 48, respectively.

The drives 34, 36 and 40 and their associated computer-readable media (38, 42) provide nonvolatile storage of data, data structures, and computer-executable instructions for the computer 20. The storage media of FIG. 5 are merely examples and it is known by those skilled in the art to include other types of media that are readable by a computer (e.g., magnetic cassettes, flash memory cards, digital video disks, etc.).

A number of program modules may be stored in the drives 34, 36 and 40 and the RAM 30, including an operating system 50, one or more application programs 52, other program modules 54 and program data 56. A user may enter commands and information into the computer 20 through a keyboard 58 and an input device 60 (e.g., mouse, microphone, joystick, game pad, satellite dish, scanner etc.) These devices (58 and 60) are connected to the processing unit 22 through a port interface 62 (e.g., serial port, parallel port, game port, universal serial bus (USB) etc.) that is coupled to the bus 26. A monitor 64 or other type of display device is also connected to the bus 26 through an interface 66 (e.g., video adapter).

The computer 20 may operate in a networked environment using logical connections to one or more remote computers, such as remote computer 68. The remote computer 68 may be a server, a router, a peer device or other common network node, and typically includes many or all of the elements described in relation to the computer 20, although for simplicity only a memory storage device 70 is shown. The logical connections shown in FIG. 5 include a local area network (LAN) 72 and a wide area network (WAN) 74. Such networking environments are commonly used in offices, enterprise-wide computer networks, intranets and the Internet.

When used in a LAN networking environment, the computer 20 is connected to the LAN 72 through a network interface or adapter 76. When used in the WAN networking environment, the computer 20 typically includes a modem 78 or other means for establishing communications over the WAN 74, such as the Internet. The modem 54, which may be internal or external, is connected to the bus 26 through the port interface 62. In a networked environment, program modules depicted relative to the computer 20, or portions thereof, may be stored in the remote memory storage device 70.

It will be apparent to one skilled in the art that numerous modifications and departures from the specific embodiments described herein may be made without departing from the spirit and scope of the present invention.

1. A method of creating a resource of a desired type ready for use in a resource management system having a plurality of templates each defining a resource category and a plurality of catalogs each specifying a resource type, each catalog in the plurality of catalogs being associated with one of the plurality of templates, each template and each catalog having associated primary validations, relationship constraints and secondary validations, the method comprising steps for:
selecting a catalog, based on the desired type, from the plurality of catalogs;
identifying a template from the plurality of templates that is associated with the catalog;
creating an initial instance of the resource;
establishing a plurality of attributes associated with the resource based on definitions specified by the catalog and by the template, and validating the attributes by applying primary validations associated with the catalog and with the template;
establishing relationships with the resource by applying relationship constraints associated with the template and with the catalog; and
applying secondary validations associated with the catalog and with the template to the attributes associated with the resource.

2. The method of claim 1 wherein the resource is a proxy in the resource management system for a physical or conceptual resource outside of the resource management system.

3. The method of claim 1 wherein the primary validations make reference to an attribute within the plurality of attributes to be validated.

4. The method of claim 1 wherein the secondary validations make reference to an attribute within the plurality of attributes to be validated and to another attribute within the plurality of attributes.

5. The method of claim 1 wherein the secondary validations can be providing by business rules.

6. A data structure used in creating a resource of a desired resource type within a resource management application according to the method of claim 1, comprising data elements representing:
a template defining a resource category;
a catalog, associated with the template, specifying a resource type;
an attribute master set;
a template subset of attributes, selected from the attribute master set, and attribute primary validations associated with the template;
a catalog subset of attributes, selected from the template subset of attributes, and primary attribute validations associated with the catalog;
relationship constraints associated with the template;
relationship constraints associated with the catalog;
secondary validations associated with the template; and
secondary validations associated with the catalog.

7. A computer program product for use in creating a resource of a desired type ready for use in a resource management system having a plurality of templates each defining a resource category and a plurality of catalogs each specifying a resource type, each catalog in the plurality of catalogs being associated with one of the plurality of templates, each template and each catalog having associated primary validations, relationship constraints and secondary validations, the computer program product comprising computer executable program code devices for:
a) selecting a catalog, based on the desired type, from the plurality of catalogs;
b) identifying a template from the plurality of templates that is associated with the catalog;
c) creating an initial instance of the resource;
d) establishing a plurality of attributes associated with the resource based on definitions specified by the catalog and by the template, and validating the attributes by applying primary validations associated with the catalog and with the template;
e) establishing relationships with the resource by applying relationship constraints associated with the template and with the catalog; and
f) applying secondary validations associated with the catalog and with the template to the attributes associated with the resource.

8. The computer program product of claim 7 wherein the resource is a proxy in the resource management system for a physical or conceptual resource outside of the resource management system.

9. The computer program product of claim 7 wherein the primary validations make reference to an attribute within the plurality of attributes to be validated.

10. The computer program product of claim 7 wherein the secondary validations make reference to an attribute within the plurality of attributes to be validated and to another attribute within the plurality of attributes.

11. The method of claim 1 wherein the secondary validations can be providing by business rules.
